(19) United States
(12) Patent Application Publication
(10) Pub. No.: US 2026/0161010 A1
(43) Pub. Date: Jun. 11, 2026

(54) LENS DRIVING DEVICE

(71) Applicant: AAC Microtech (Changzhou) Co., Ltd., Changzhou City (CN)

(72) Inventors: Zhang Ren, Changzhou (CN); Wei Song, Changzhou (CN); Suohe Wei, Changzhou (CN)

(21) Appl. No.: 19/073,051

(22) Filed: Mar. 7, 2025

Related U.S. Application Data
(63) Continuation of application No. PCT/CN2024/138504, filed on Dec. 11, 2024.

(51) Int. Cl. G02B 27/64

(52) U.S. Cl. CPC G02B 27/646

(57) ABSTRACT

A lens driving device, including a case having an accommodating space, an elastic bracket, a circuit board assembly, a driving coil, a magnet assembly and an image sensor. The driving coil is spaced from the magnet assembly. The driving coil includes a first coil set and a second coil set. The magnet assembly includes a first magnet unit spaced from the first coil set and a second magnet unit spaced from the second coil set. The first coil set works together with the first magnet unit to drive the circuit board assembly to move along a first direction, and the second coil set works together with the second magnet unit to drive the circuit board assembly to move along a second direction perpendicular to the first direction. First and second directions are perpendicular to the optical axis direction. The lens driving device has a good image stabilization driving effect.

### TECHNICAL FIELD

The present disclosure relates to the technical field of image stabilization, and in particular, to a lens driving device.

### BACKGROUND

With the growing demand for enhanced shooting experiences, an image stabilization function of a lens driving device has found widespread applications in various imaging devices. The combination of the lens driving device and various portable electronic devices such as mobile phones, cameras, and computers is favored by consumers.

An image stabilization device of a lens driving device in the related art generally includes a case, a circuit board provided in the case, a magnet or a coil fixed to the circuit board, a coil or a magnet fixed to the case, and a lens bracket fixed to the circuit board. A lens module is fixed to the lens bracket, and the circuit board is elastically supported by means of an elastic piece. When a current is applied to the coil, an electromagnetic field is generated between the coil and a magnet set, and the coil is driven by a Lorentz force of the electromagnetic field to drive the lens bracket to move along a direction perpendicular to an optical axis, thereby driving the lens module to achieve an image stabilization performance. However, in such an image stabilization device, a driving effect of a single coil and magnet is relatively poor, leading to a poor image stabilization effect.

In view of this, the present disclosure provides a new lens driving device to solve the above-mentioned technical problems.

### SUMMARY

An object of the present disclosure is to provide a lens driving device with a low overall cost, a good driving effect and a better image stabilization effect.

In an aspect, an embodiment of the present disclosure provides a lens driving device, including: a case; an elastic bracket fixed in the case; a circuit board assembly supported at the elastic bracket; a driving coil stacked and fixed to the circuit board assembly and electrically connected to the circuit board assembly; a magnet assembly fixed to the case; and an image sensor fixed to the circuit board assembly. The case is provided with an opening penetrating therethrough along an optical axis direction of the image sensor, the driving coil is arranged at a corner position of the circuit board assembly, and the driving coil is spaced from the magnet assembly. The driving coil includes a first coil set and a second coil set spaced from each other, the first coil set is arranged along a diagonal line of the circuit board assembly, and the second coil set is arranged along another diagonal line of the circuit board assembly; the magnet assembly includes a first magnet unit spaced from the first coil set and a second magnet unit spaced from the second coil set, and the first magnet unit is a Halbach magnetic circuit; and the first coil set works together with the first magnet unit to drive the circuit board assembly to move along a first direction, and the second coil set works together with the second magnet unit to drive the circuit board assembly to move along a second direction, the first direction and the second direction being perpendicular to each other and both perpendicular to the optical axis direction.

As an improvement, the first coil set includes a first coil and a second coil that are fixed to the circuit board assembly and arranged side by side along the first direction. The first magnet unit includes a first magnet, a second magnet, a third magnet, a fourth magnet, a fifth magnet and a sixth magnet that are fixed to the case and arranged side by side along the first direction. The first magnet, the second magnet and the third magnet are opposite to the first coil; and the fourth magnet, the fifth magnet and the sixth magnet are opposite to the second coil.

As an improvement, the first magnet, the third magnet, the fourth magnet, and the sixth magnet are all magnetized along an extending direction of the optical axis direction; and the second magnet and the fifth magnet are both magnetized along a direction perpendicular to the optical axis direction.

As an improvement, the first coil and the second coil are formed as an integral structure by integrated winding; or the first coil and the second coil are formed as two separate coils that are connected to each other in series.

As an improvement, the third magnet and the fourth magnet are formed as an integral structure.

As an improvement, the third magnet and the fourth magnet are formed as separate structures.

As an improvement, the lens driving device further includes a first magnetic conductive sheet, the first magnetic conductive sheet is stacked and fixed to a side of the magnet assembly away from the driving coil; and the case is provided with an aperture penetrating therethrough, and the first magnetic conductive sheet is arranged in the aperture.

As an improvement, the lens driving device further includes a second magnetic conductive sheet that is fixed to the case, the second magnetic conductive sheet is arranged at a side of the driving coil away from the magnet assembly, and the second magnetic conductive sheet is opposite to the magnet assembly.

As an improvement, the elastic bracket includes a first fixation portion fixed to the case, a second fixation portion fixed to the circuit board assembly, and a connection portion connecting the first fixation portion and the second fixation portion.

As an improvement, the circuit board assembly includes a first circuit board and a second circuit board stacked to the first circuit board, the driving coil is fixedly connected to the second circuit board, and the first circuit board and the second circuit board are soldered for fixation.

As an improvement, the lens driving device further includes a vibration damping member fixed to a surface of the circuit board assembly away from the magnet assembly.

As an improvement, the lens driving device further includes an anti-collision block fixed to each side surface of the circuit board assembly, the second fixation portion of the elastic bracket is fixedly connected to the anti-collision block.

As an improvement, the lens driving device further includes a connection member for connecting adjacent anti-collision blocks.

Compared with the solutions in the related art, for a lens driving device provided by the present disclosure, the driving coil and the magnet assembly are fixed to the circuit board assembly and the case, respectively; the case is provided with an opening penetrating therethrough along an optical axis direction of the image sensor; the driving coil is provided at a corner position of the circuit board assembly, and the driving coil is spaced from the magnet assembly; the driving coil includes a first coil set and a second coil set spaced from each other; the first coil set is arranged along a diagonal line of the circuit board assembly, and the second coil set is arranged along another diagonal line of the circuit board assembly; the magnet assembly includes a first magnet unit spaced from the first coil set and a second magnet unit spaced from the second coil set, and the first magnet unit is a Halbach magnetic circuit; the first coil set works together with the first magnet unit to drive the circuit board assembly to move along a first direction, and the second coil set works together with the second magnet unit to drive the circuit board assembly to move along a second direction; the first direction and the second direction are perpendicular to each other and are both perpendicular to the optical axis direction; a driving force can be increased in a micro space by means of the coil and the magnet of a specific structure, so that the lens driving device has a good driving image stabilization effect.

### BRIEF DESCRIPTION OF DRAWINGS

In order to better illustrate the technical solutions in embodiments of the present disclosure, the drawings required to be used in the description of the embodiments will be briefly described below. It is appreciated that, the drawings in the following description are only some embodiments of the present disclosure, and for those skilled in the art, other drawings can also be obtained according to these accompanying drawings without creative effort.

FIG. 1 is a perspective view of a lens driving device according to an embodiment of the present disclosure;

FIG. 2 is a partial structural exploded view of a lens driving device according to an embodiment of the present disclosure;

FIG. 3 is a perspective structural exploded view of a lens driving device according to an embodiment of the present disclosure;

FIG. 4 is a sectional view along A-A shown in FIG. 1;

FIG. 5 is a sectional view along B-B shown in FIG. 1;

FIG. 6 is a schematic diagram of a magnetic pole of a first magnet unit according to an embodiment of the present disclosure; and

FIG. 7 is a schematic diagram of an elastic bracket according to an embodiment of the present disclosure.

### Reference signs

100. lens driving device;
1. case;
101. bottom lid;
102. upper lid;
103. opening;
104. aperture;
2. elastic bracket;
21. first fixation portion;
22. second fixation portion;
23. connection portion;
3. circuit board assembly;
31. first circuit board;
32. second circuit board;
33. through hole;
4. driving coil set;
41. first coil set;
411. first coil;
412. second coil;
42. second coil set;
5. magnet assembly;
51. first magnet unit;
511. first magnet;
512. second magnet;
513. third magnet;
514. fourth magnet;
515. fifth magnet;
516. sixth magnet;
52. second magnet unit;
6. first magnetic conductive sheet;
7. second magnetic conductive sheet;
8. vibration damping member;
9. anti-collision block;
91. first anti-collision block;
92. second anti-collision block;
93. connection member;
10. electric-conductive connection plate;
11. frame;
12. image sensor;
13. optical filter;
14. first driving chip;
15. second driving chip;
16. sensor bracket.

### DESCRIPTION OF EMBODIMENTS

The technical solutions in the embodiments of the present disclosure are described in the following with reference to the accompanying drawings. It should be noted that, the described embodiments are merely exemplary embodiments of the present disclosure, which shall not be interpreted as providing limitations to the present disclosure. All other embodiments obtained by those skilled in the art without creative efforts according to the embodiments of the present disclosure shall fall within a scope of the present disclosure.

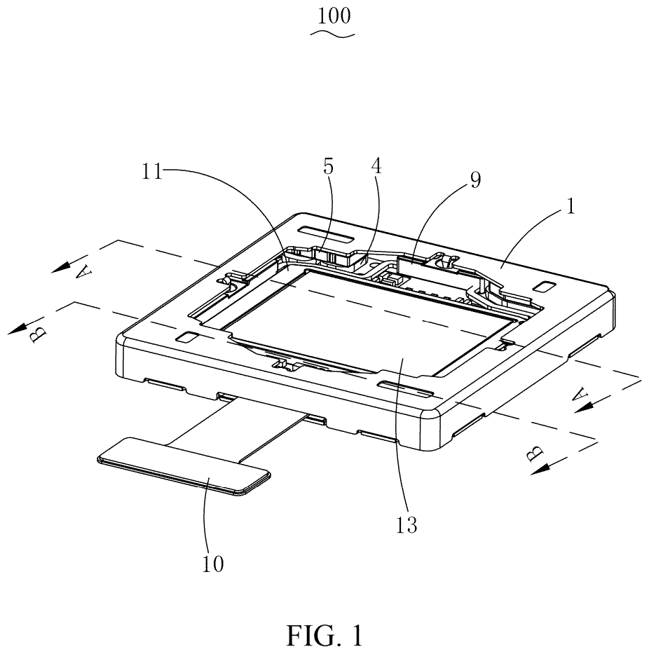

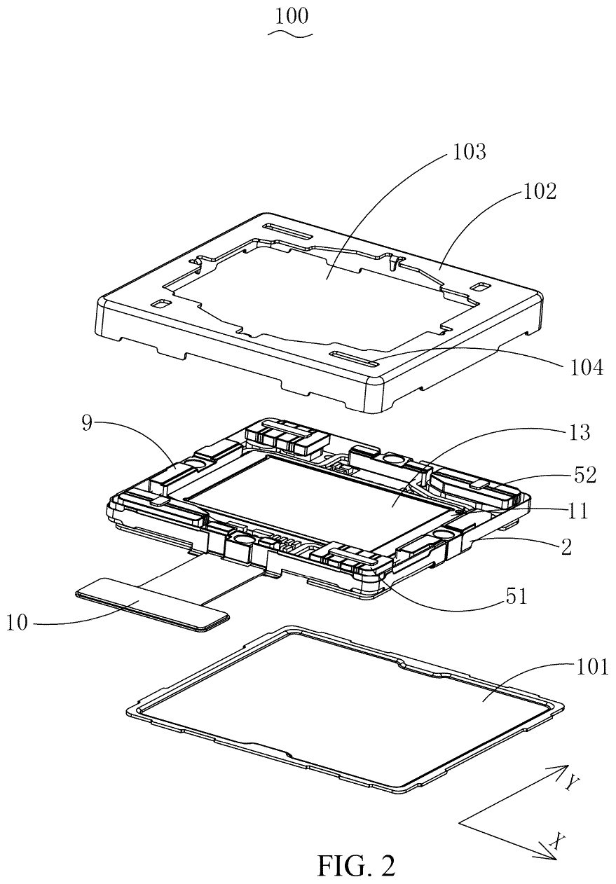

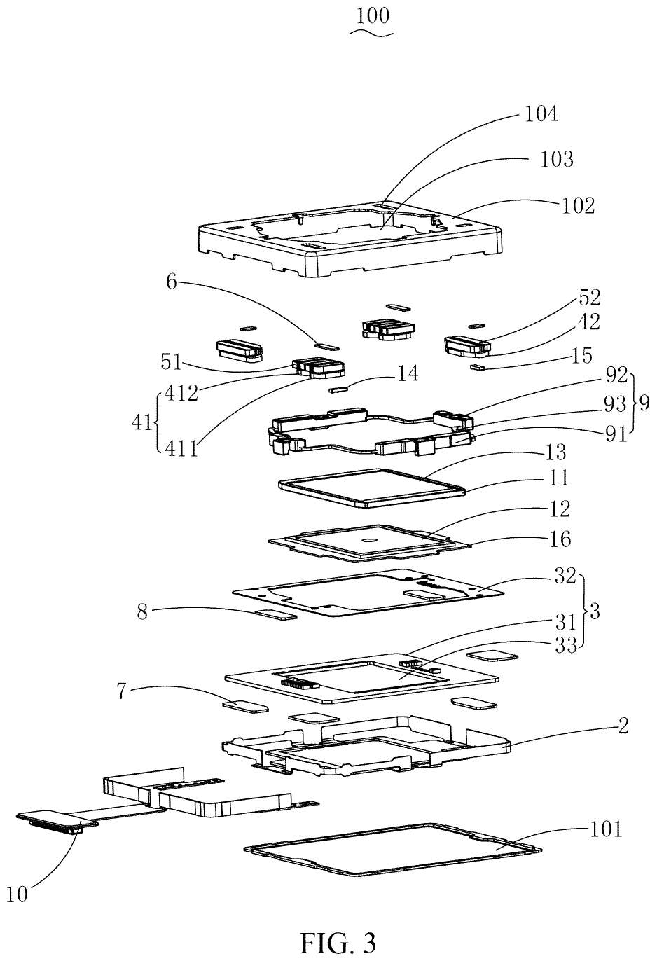

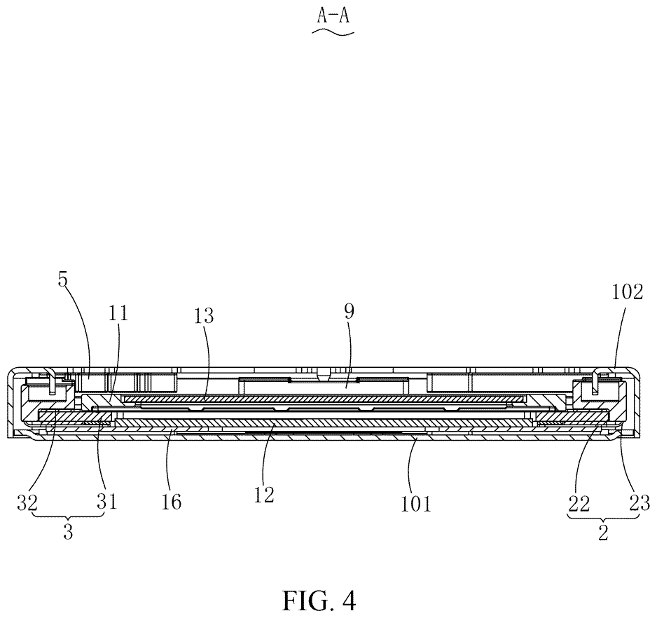

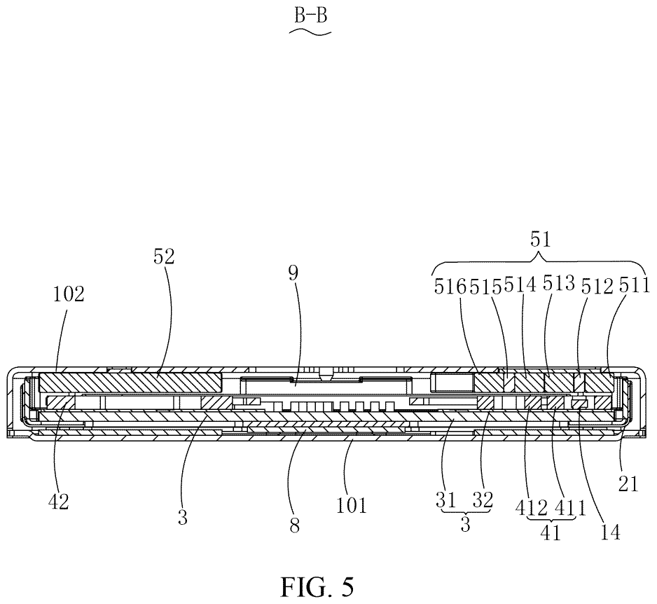

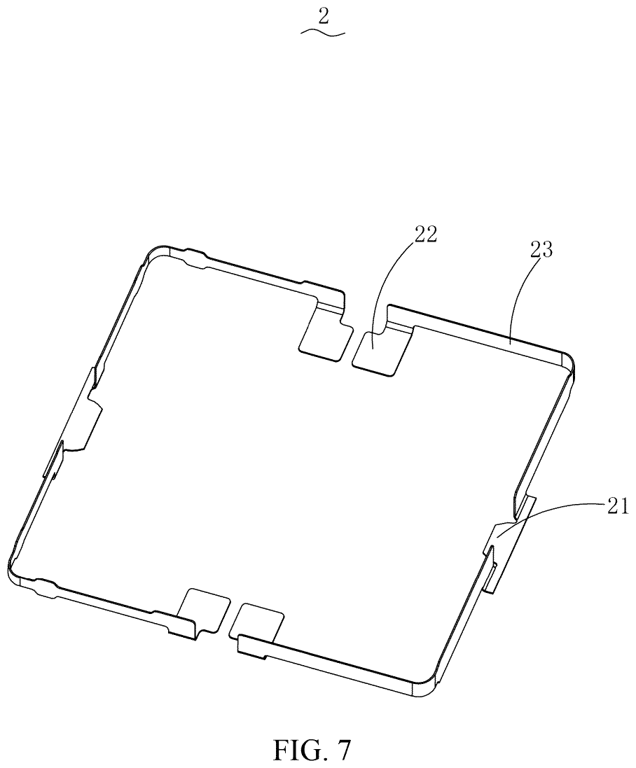

As shown in FIG. 1 to FIG. 7, an embodiment of the present disclosure provides a lens driving device 100, including: a case 1, an elastic bracket 2 fixed in the case 1, a circuit board assembly 3 supported at the elastic bracket 2, a driving coil 4 stacked and fixed to the circuit board assembly 3 and electrically connected to the circuit board assembly 3, a magnet assembly 5 fixed in the case 1, and an image sensor 12 fixed to the circuit board assembly 3. The case 1 is provided with an opening 103 penetrating therethrough along an optical axis direction of the image sensor 12. The driving coil 4 is arranged at a corner position of the circuit board assembly, and the driving coil 4 is spaced from the magnet assembly 5.

In an example, the lens driving device 100 further includes a frame 11 and an optical filter 13. The frame 11 is opposite to the opening 103 and is fixed to the circuit board assembly 3, and the optical filter 13 is mounted and fixed to the frame 11.

In an example, the driving coil 4 includes a first coil set 41 and a second coil set 42 spaced from each other. The first coil set 41 is arranged along a diagonal line of the circuit board assembly 3, and the second coil set 42 is arranged along another diagonal line of the circuit board assembly 3. The magnet assembly 5 includes a first magnet unit 51 spaced from the first coil set 41 and a second magnet unit 52 spaced from the second coil set 42. The first magnet unit 51 is a Halbach magnetic circuit. The first coil set 41 works together with the first magnet unit 51 to drive the circuit board assembly 3 to move along a first direction (X-axis). The second coil set 42 works together with the second magnet unit 52 to drive the circuit board assembly 3 to move along a second direction (Y-axis). The first direction is perpendicular to the second direction, and both the first direction and the second direction are perpendicular to the optical axis direction. A driving force can be increased in a micro space by means of multiple sets of coils and magnets, so that the lens driving device 100 has a good driving image stabilization effect.

In an example, the lens driving device 100 further includes a first driving chip 14 and a second driving chip 15. The first driving chip 14 is arranged in the first coil set 41, and the second driving chip 15 is arranged in the second coil set 42. The first driving chip 14 is configured to control the first coil set 41 to move along the first direction. The second driving chip 15 is configured to control the second coil set 42 to move along the second direction.

In an embodiment of the present disclosure, the first coil set 41 includes a first coil 411 and a second coil 412 fixed to the circuit board assembly 3 and arranged side by side along the first direction, and the first driving chip 45 is arranged in the first coil 411. The first magnet unit 51 includes a first magnet 511, a second magnet 512, a third magnet 513, a fourth magnet 514, a fifth magnet 515, and a sixth magnet 516 that are fixed to the case 1 and arranged side by side along the first direction. The first magnet 511, the second magnet 512 and the third magnet 513 are fixedly connected to each other and are opposite to the first coil 411. The fourth magnet 514, the fifth magnet 515 and the sixth magnet 516 are fixedly connected to each other and are opposite to the second coil 412. A driving force can be increased in a micro space by configuring multiple sets of coils and magnets, so that the lens driving device 100 has a good driving image stabilization effect.

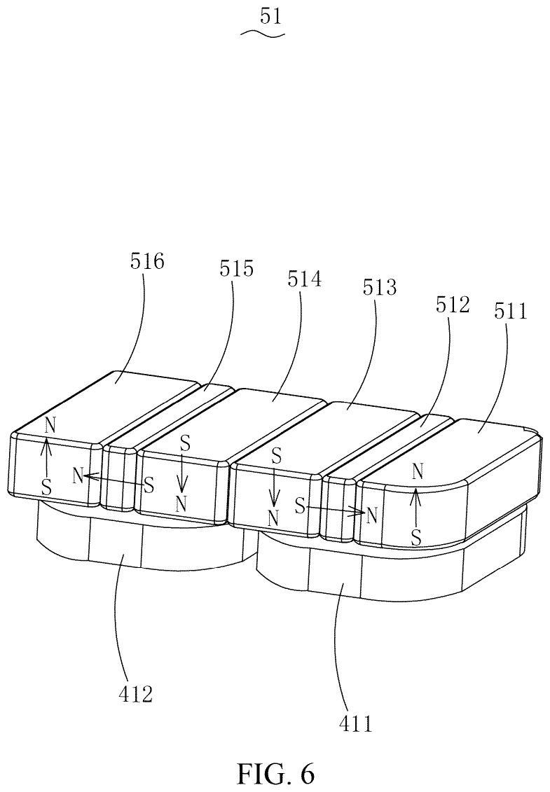

In an embodiment of the present disclosure, as shown in FIG. 6, the first magnet 511, the third magnet 513, the fourth magnet 514, and the sixth magnet 516 are all magnetized along an extending direction of the optical axis direction, and the second magnet 512 and the fifth magnet 515 are both magnetized along a direction perpendicular to the optical axis direction.

In an example, a magnetic pole of the first magnet 511 at a side away from the driving coil 4 and a magnetic pole of the sixth magnet 516 at a side away from the driving coil 4 are both N poles, and a magnetic pole of the first magnet 511 at a side adjacent to the driving coil 4 and a magnetic pole of the sixth magnet 516 at a side adjacent to the driving coil 4 are both S poles. A magnetic pole of the third magnet 513 at a side away from the driving coil 4 and a magnetic pole of the fourth magnet 514 at a side away from the driving coil 4 are both S poles, and a magnetic pole of the third magnet 513 at a side adjacent to the driving coil 4 and a magnetic pole of the fourth magnet 514 at a side adjacent to the driving coil 4 are both N poles. A magnetic pole of the second magnet 512 at a side adjacent to the first magnet 511 is an N pole, and a magnetic pole of the second magnet 512 at a side away from the first magnet 511 is an S pole. A magnetic pole of the fifth magnet 515 at a side adjacent to the sixth magnet 516 is an N pole, and a magnetic pole of the fifth magnet 515 at a side away from the sixth magnet 516 is an S pole.

In an embodiment of the present disclosure, the second coil set 42 is a coil, which is soldered to the circuit board assembly 3, and the second magnet unit 52 includes three magnets, thereby saving a certain cost to ensure a sufficient driving force.

In other embodiments of the present disclosure, the second magnet unit 52 can also be a Halbach magnetic circuit, and the coil of the second coil set 42 is also arranged in correspondence with the second magnet unit 52. In such case, the lens driving device 100 has an excellent driving force in both the X direction and the Y direction, with a better image stabilization effect.

In an embodiment of the present disclosure, an orthographic projection of the first coil 411 towards the second coil 412 at least partially or completely falls within a scope of the second coil 412.

In an embodiment of the present disclosure, the first coil 411 and the second coil 412 are formed by integrated winding; or, the first coil 411 and the second coil 412 are two separate coils, and are connected to each other in series. Integrated winding can save two welding pads and save a mounting space.

In an embodiment of the present disclosure, the third magnet 513 and the fourth magnet 514 are formed as an integral structure.

In an embodiment of the present disclosure, the second magnet 513 and the third magnet 514 are formed as separate structures. The mounting of the third magnet 513 and the fourth magnet 514 can be facilitated, and meanwhile, the magnetic field performance can be improved.

In an embodiment of the present disclosure, the lens driving device 100 further includes a first magnetic conductive sheet 6, and the first magnetic conductive sheet 6 is stacked and fixed to a side of the first magnet unit 51 away from the first coil set 41. A magnetic conductive effect of the magnet is enhanced by means of the first magnetic conductive sheet 6. The case 1 is provided with an aperture 104 penetrating therethrough, and the first magnetic conductive sheet 6 is arranged in the aperture 104, thereby facilitating mounting of the first magnetic conductive sheet 6, and saving an overall stacking space of the lens driving device 100. In an example, the first magnetic conductive sheet 6 is completely arranged in the aperture 104.

In an embodiment of the present disclosure, the lens driving device 100 further includes a second magnetic conductive sheet 7 that is fixed to the case 1. The second magnetic conductive sheet 7 is arranged at a side of the driving coil 4 away from the magnet assembly 5, and the second magnetic conductive sheet 7 is opposite to the magnet assembly 5, thereby enhancing the magnetic conductivity.

In an embodiment of the present disclosure, the elastic bracket 2 includes a first fixation portion 21 fixed to the case 1, a second fixation portion 22 fixed to the circuit board assembly 3, and a connection portion 23 connecting the first fixation portion 21 and the second fixation portion 22. The first fixation portion 21 is fixed to the case 1, the circuit board assembly 3 is fixed to the second fixation portion 22, and an elastic connection is formed between the first fixation portion 21 and the second fixation portion 22 by means of the connection portion 23, then when the driving coil 4 and the magnet assembly 5 are driven by each other, the image sensor 12 is driven to move with image stabilization.

In an embodiment of the present disclosure, the circuit board assembly 3 includes a first circuit board 31 and a second circuit board 32 stacked to the first circuit board 31. The first circuit board 31 and the second circuit board 32 are soldered for fixation, and the driving coil 4 is fixedly connected to the second circuit board 32. For example, the driving coil 4 is soldered and fixed to the second circuit board 32. The first circuit board 31 is a printed circuit board (PCB), and the second circuit board 32 is a flexible circuit board (FPC). By soldering the driving coil 4 and the second circuit board 32, an undesirable output movement of the second circuit board 32 can be reduced, and the control circuit can be merged with the first circuit board 31 after being processed separately.

In an embodiment of the present disclosure, the lens driving device 100 further includes a vibration damping member 8 correspondingly, and the vibration damping member 8 is fixed to a surface of the circuit board assembly 3 away from the magnet assembly 5. The vibration damping member 8 can be used to provide a vibration damping effect on the circuit board assembly 3 that moves. In an example, the vibration damping member 8 may be fixed to each of four corners of a surface of the circuit board assembly 3 away from the magnet assembly 5, so that the vibration damping effect is better.

In an embodiment of the present disclosure, the vibration damping member 8 may be made of a silica gel or rubber material.

In an embodiment of the present disclosure, the lens driving device 100 further includes an anti-collision block 9 fixed to each side surface of the circuit board assembly 3, and the second fixation portion 22 of the elastic bracket 2 is fixedly connected to the anti-collision block 9. The anti-collision block 9 includes a first anti-collision block 91 fixed to each of two sides of the circuit board assembly 3, and a second anti-collision block 92 fixed to each of another two sides of the circuit board assembly 3. The frame 11 is arranged between the first anti-collision block 91 and the second anti-collision block 92. The first anti-collision block 91 and the second anti-collision block 92 can be further configured to limit a rotation position of the circuit board assembly 3, to prevent the image sensor 12 from rotating excessively. For example, the first anti-collision block 91 and the second anti-collision block 92 have a large contact area with the elastic bracket 2, thereby facilitating improving the stability of the first anti-collision block 91 and the second anti-collision block 92.

In an embodiment of the present disclosure, the lens driving device 100 further includes a connection member 93, and two ends of the connection member 93 are respectively fixed to the first anti-collision block 91 and the second anti-collision block 92, to form an integral structure, thereby improving the stability.

In an embodiment of the present disclosure, the case 1 includes a bottom lid 101 and an upper lid 102 fixed to the bottom lid 101. The elastic bracket 2 is fixed to the bottom lid 101. The magnet assembly 5 is fixed to the upper lid 102. The opening 103 is formed at the upper lid 102.

In an embodiment of the present disclosure, the lens driving device 100 further includes an electric-conductive connection plate 10. An end of the electric-conductive connection plate 10 is fixed to the circuit board assembly 3, and another end of the electric-conductive connection plate 10 extends to an outer side of the case 1 to be connected to an external power supply.

In an embodiment of the present disclosure, the lens driving device 100 further includes a sensor bracket 16 fixed to the second circuit board 32. The sensor bracket 16 is fixed to the second circuit board 32 and covers the through hole 33. The image sensor 10 is fixed to a side of the sensor bracket 16 facing the opening 103 and is arranged in the through hole 33.

Compared with the solutions in the related art, for a lens driving device provided by the present disclosure, the driving coil and the magnet assembly are fixed to the circuit board assembly and the case, respectively; the case is provided with an opening penetrating therethrough along an optical axis direction of the image sensor; the driving coil is provided at a corner position of the circuit board assembly, and the driving coil is spaced from the magnet assembly; the driving coil includes a first coil set and a second coil set spaced from each other; the first coil set is arranged along a diagonal line of the circuit board assembly, and the second coil set is arranged along another diagonal line of the circuit board assembly; the magnet assembly includes a first magnet unit spaced from the first coil set and a second magnet unit spaced from the second coil set, and the first magnet unit is a Halbach magnetic circuit; the first coil set works together with the first magnet unit to drive the circuit board assembly to move along a first direction, and the second coil set works together with the second magnet unit to drive the circuit board assembly to move along a second direction; the first direction and the second direction are perpendicular to each other and are both perpendicular to the optical axis direction; a driving force can be increased in a micro space by means of the coil and the magnet of a specific structure, so that the lens driving device has a good driving image stabilization effect.

The above description merely illustrates some embodiments of the present disclosure. It should be noted that those skilled in the art may make improvements without departing from a creative concept of the present disclosure, but all these improvements shall fall into a scope of the present disclosure.

What is claimed is:

1. A lens driving device, comprising:
a case;
an elastic bracket fixed in the case;
a circuit board assembly supported at the elastic bracket;
a driving coil stacked and fixed to the circuit board assembly and electrically connected to the circuit board assembly;
a magnet assembly fixed to the case; and
an image sensor fixed to the circuit board assembly,
wherein the case is provided with an opening penetrating therethrough along an optical axis direction of the image sensor, the driving coil is arranged at a corner position of the circuit board assembly, and the driving coil is spaced from the magnet assembly; and
wherein the driving coil comprises a first coil set and a second coil set spaced from each other, the first coil set is arranged along a diagonal line of the circuit board assembly, and the second coil set is arranged along another diagonal line of the circuit board assembly; the magnet assembly comprises a first magnet unit spaced from the first coil set and a second magnet unit spaced from the second coil set, and the first magnet unit is a Halbach magnetic circuit; and the first coil set works together with the first magnet unit to drive the circuit board assembly to move along a first direction, and the second coil set works together with the second magnet unit to drive the circuit board assembly to move along a second direction, the first direction and the second direction being perpendicular to each other and both perpendicular to the optical axis direction.

2. The lens driving device as described in claim 1,
wherein the first coil set comprises a first coil and a second coil that are fixed to the circuit board assembly and arranged side by side along the first direction;
wherein the first magnet unit comprises a first magnet, a second magnet, a third magnet, a fourth magnet, a fifth magnet and a sixth magnet that are fixed to the case and arranged side by side along the first direction; and
wherein the first magnet, the second magnet and the third magnet are opposite to the first coil; and the fourth magnet, the fifth magnet and the sixth magnet are opposite to the second coil.

3. The lens driving device as described in claim 2, wherein the first magnet, the third magnet, the fourth magnet, and the sixth magnet are all magnetized along an extending direction of the optical axis direction; and the second magnet and the fifth magnet are both magnetized along a direction perpendicular to the optical axis direction.

4. The lens driving device as described in claim 2, wherein the first coil and the second coil are formed as an integral structure by integrated winding; or the first coil and the second coil are formed as two separate coils that are connected to each other in series.

5. The lens driving device as described in claim 2, wherein the third magnet and the fourth magnet are formed as an integral structure.

6. The lens driving device as described in claim 2, wherein the third magnet and the fourth magnet are formed as separate structures.

7. The lens driving device as described in claim 1, further comprising a first magnetic conductive sheet, wherein the first magnetic conductive sheet is stacked and fixed to a side of the magnet assembly away from the driving coil; and the case is provided with an aperture penetrating therethrough, and the first magnetic conductive sheet is arranged in the aperture.

8. The lens driving device as described in claim 1, further comprising a second magnetic conductive sheet that is fixed to the case, wherein the second magnetic conductive sheet is arranged at a side of the driving coil away from the magnet assembly, and the second magnetic conductive sheet is opposite to the magnet assembly.

9. The lens driving device as described in claim 1, wherein the elastic bracket comprises a first fixation portion fixed to the case, a second fixation portion fixed to the circuit board assembly, and a connection portion connecting the first fixation portion and the second fixation portion.

10. The lens driving device as described in claim 1, wherein the circuit board assembly comprises a first circuit board and a second circuit board stacked to the first circuit board, the driving coil is fixedly connected to the second circuit board, and the first circuit board and the second circuit board are soldered for fixation.

11. The lens driving device as described in claim 1, further comprising a vibration damping member fixed to a surface of the circuit board assembly away from the magnet assembly.

12. The lens driving device as described in claim 9, further comprising an anti-collision block fixed to each side surface of the circuit board assembly, wherein the second fixation portion of the elastic bracket is fixedly connected to the anti-collision block.

13. The lens driving device as described in claim 12, further comprising a connection member for connecting adjacent anti-collision blocks.
